(19) United States
(12) Patent Application Publication
(10) Pub. No.: US 2023/0334802 A1
(43) Pub. Date: Oct. 19, 2023

(54) EYES REPRODUCTION SYSTEM, METHOD AND PROGRAM

(71) Applicant: Nippon Telegraph and Telephone Corporation, Tokyo (JP)

(72) Inventors: Motohiro Makiguchi, Musashino-shi, Tokyo (JP); Masanori YOKOYAMA, Musashino-shi, Tokyo (JP); Kimitaka TSUTSUMI, Musashino-shi, Tokyo (JP); Takashi SATO, Musashino-shi, Tokyo (JP)

(21) Appl. No.: 18/017,711

(22) PCT Filed: Jul. 29, 2020
(86) PCT No.: PCT/JP2020/029038

§ 371 Date: Jan. 24, 2023

(51) Int. Cl. G06T 19/20; G06T 13/40

(52) U.S. Cl. CPC G06T 19/20; G06T 13/40; G06T 2219/2004

(57) ABSTRACT

There is provided a line-of-sight reproduction system including a pseudo eyeball model generation device 10 and a display device 20, in which the pseudo eyeball model generation device 10 generates a pseudo eyeball model 30 representing a pseudo eyeball with virtual eyeball information indicating a virtual eyeball 31 and pseudo pupil information obtained by moving a position of a pseudo pupil 32 from a surface of the virtual eyeball 31 to a side of an observer in association with a degree of gaze avoidance of deviating an eye line from a viewpoint 40 of the observer, and the display device 20 renders a pseudo eyeball image representing the pseudo eyeball based on the pseudo eyeball model 30, and then renders a display image of another display element.

### TECHNICAL FIELD

The present invention relates to a line-of-sight reproduction system, a line-of-sight reproduction method, and a program.

### BACKGROUND ART

In communication between persons, not only a gesture of matching the line of sight with a person facing another, but also a gesture of not matching the line of sight are important non-language information. In pictures, signboards, or the like, there is a method of using an illusion using two-layer display surfaces as a classical method for matching the line of sight of a person displayed, for example, with an observer at an arbitrary position in a real space.

Also, for example, in NPL 1, there is disclosed a method of reproducing a state in which the line of sight of a two-dimensional virtual character is directed to a specific observer by displaying a pupil image in front of a face image by using a two-layer display.

### CITATION LIST

### Non Patent Literature

[NPL 1] Taro Ichii and three others, “Plane image presentation method using a two-layer display that can eliminate the Mona Lisa effect in a wide field of view without spoiling the aesthetics,” Information Processing Society of Japan, Interaction 2019.

### SUMMARY OF INVENTION

### Technical Problem

However, with the conventional techniques, although the state in which the line of sight is being sent to a specific object can be reproduced, it is not possible to reproduce an operation of not matching the line of sight (gaze avoidance). In other words, both of the conventional techniques have a problem that the state of the line of sight is determined by the depth of the two layers in terms of hardware, and it is not possible to reproduce an operation of not matching the line of sight (gaze avoidance).

The present invention has been made in view of this problem, and an object of the present invention is to provide a line-of-sight reproduction system, a line-of-sight reproduction method, and a program that can reproduce an operation of not matching the line of sight (gaze avoidance).

### Solution to Problem

A line-of-sight reproduction system according to one aspect of the present invention is a line-of-sight reproduction system including a pseudo eyeball model generation device and a display device, in which the pseudo eyeball model generation device generates a pseudo eyeball model representing a pseudo eyeball with virtual eyeball information indicating a virtual eyeball and pseudo pupil information obtained by moving a position of a pseudo pupil from a surface of the virtual eyeball to a side of an observer in association with a degree of gaze avoidance of deviating an eye line from a viewpoint of the observer, and the display device renders a pseudo eyeball image representing the pseudo eyeball based on the pseudo eyeball model, and then renders a display image of another display element.

Further, a line-of-sight reproduction method according to one aspect of the present invention is a line-of-sight reproduction method performed by the above line-of-sight reproduction system, and the method includes: generating, by the pseudo eyeball model generation device, a pseudo eyeball model representing a pseudo eyeball with virtual eyeball information indicating a virtual eyeball and pseudo pupil information obtained by moving a position of a pseudo pupil from a surface of the virtual eyeball to a side of an observer in association with a degree of gaze avoidance of deviating an eye line from a viewpoint of the observer; and rendering, by the display device, a pseudo eyeball image representing the pseudo eyeball based on the pseudo eyeball model, and then rendering, by the display device, a display image of another display element.

Furthermore, a program according to one aspect of the present invention is a program for causing a computer to function as the above line-of-sight reproduction system.

### Advantageous Effects of Invention

According to the present invention, it is possible to reproduce an operation of not matching the line of sight (gaze avoidance).

### BRIEF DESCRIPTION OF DRAWINGS

FIG. 1 is a diagram showing an example of a configuration of a line-of-sight reproduction system according to an embodiment of the present invention.

FIG. 2 is a diagram schematically showing an example of a configuration of a pseudo eyeball model.

FIG. 3 is a diagram showing a pseudo eyeball model when a pseudo pupil overlaps an eyelid.

FIG. 4 is a diagram showing an example of a configuration of a display device according to the embodiment of the present invention.

FIG. 5 is a diagram showing an example of a face image displayed on the display device shown in FIG. 4.

FIG. 6 is a diagram showing a relationship between a pseudo eyeball model and a viewpoint of an observer.

FIG. 7 is a flowchart showing a processing procedure of the line-of-sight reproduction system shown in FIG. 1.

FIG. 8 is a block diagram showing an example of a configuration of a general-purpose computer system.

### DESCRIPTION OF EMBODIMENTS

An embodiment of the present invention will be described below with reference to the drawings. The same elements in a plurality of drawings are given the same reference numerals in order not to repeat description.

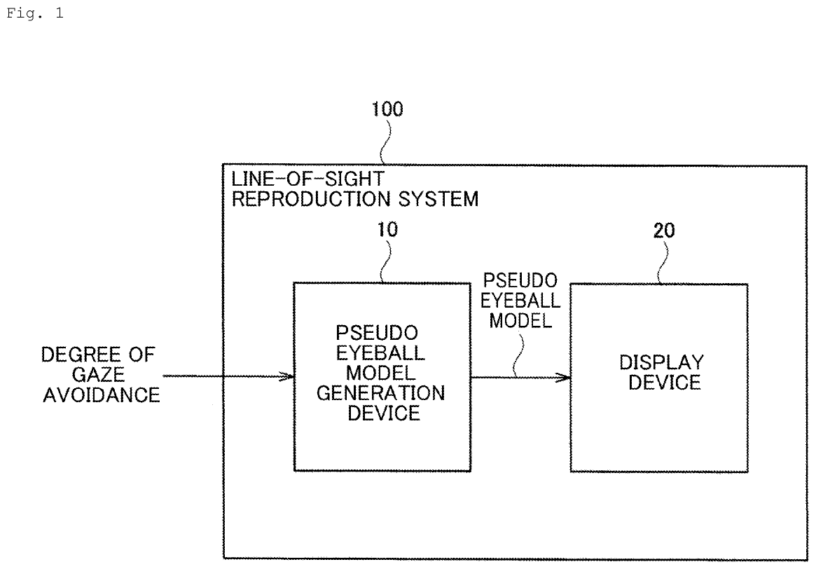

FIG. 1 is a diagram showing an example of a configuration of a line-of-sight reproduction system according to the embodiment of the present invention. A line-of-sight reproduction system 100 shown in FIG. 1 reproduces a gaze avoidance operation of deviating a viewpoint from a specific object.

The line-of-sight reproduction system 100 includes a pseudo eyeball model generation device 10 and a display device 20.

The pseudo eyeball model generation device 10 generates a pseudo eyeball model representing a pseudo eyeball with virtual eyeball information indicating a virtual eyeball and pseudo pupil information obtained by moving a position of a pseudo pupil from a surface of the virtual eyeball to a side of an observer in association with a degree of gaze avoidance of deviating an eye line from a viewpoint of the observer.

As shown in FIG. 1, information indicating a “degree of gaze avoidance” is given from the outside. The “degree of gaze avoidance” may be binary information indicating the presence or absence of gaze avoidance, or may be information having a plurality of stages such as large, medium, and small.

### (Pseudo Eyeball Model)

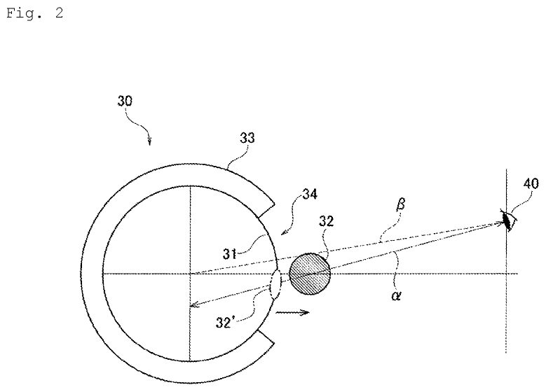

FIG. 2 is a diagram schematically showing an example of a configuration of a pseudo eyeball model.

The pseudo eyeball model 30 shown in FIG. 2 includes virtual eyeball information indicating a virtual eyeball 31, pseudo pupil information indicating a pseudo pupil 32, and opening information indicating an eyelid 33. The virtual eyeball 31 is transparent or translucent, and an observer can visually recognize the pseudo pupil 32 without this being shielded by the virtual eyeball 31.

In FIG. 2, reference numeral 40 denotes a viewpoint of the observer. As shown in FIG. 2, the position of the pseudo pupil 32 is moved from the surface of the virtual eyeball 31 to the observer side and disposed in association with a degree of gaze avoidance of deviating an eye line from the viewpoint 40 of the observer.

When the pseudo pupil 32 is disposed in this manner, a straight line α indicated by an alternate long and short dashed line connecting the viewpoint 40 of the observer and the center of the pseudo pupil 32 is located inside a straight line β indicated by a broken line connecting the viewpoint 40 and the center of the virtual eyeball 31. The observer feels a stronger degree of gaze avoidance as the difference between the straight lines β and α is larger. On the other hand, the observer feels that the line of sight matches as the straight lines β and α are closer.

Further, in the case of the example shown in FIG. 2, the observer perceives that the center of the pseudo pupil 32 is located below a horizontal line passing through the center of the virtual eyeball 31 as shown by an ellipse 32′ of a two-dot dashed line. Thus, the observer can perceive the line of sight as being more deviated.

The eyelid 33 is not limited to the shape shown in FIG. 2 in which a portion of the annulus is removed. The opening information indicating the eyelid 33 may be any information as long as the opening 34 can be formed. The eyelid 33 may have a planar shape (not shown) in which a part of the virtual eyeball 31 and the pseudo pupil 32 can be seen. In other words, the pseudo eyeball model 30 may not include opening information indicating the opening corresponding to the eyelid.

Further, a face image of a person may be drawn on the surface of the planar member. In that case, the display device 20 only needs to display the pseudo eyeball image in accordance with the position of the opening of the eyelid 33 of the face image panel. In other words, the display device 20 does not need to display the face image. The display device 20 will be described in detail later.

When the pseudo pupil 32 is disposed outside the virtual eyeball 31, the pseudo pupil 32 is drawn in front of the eyelid 33 in the normal rendering of a 3D image, and thus contradiction may occur in occlusion (overlapping expression).

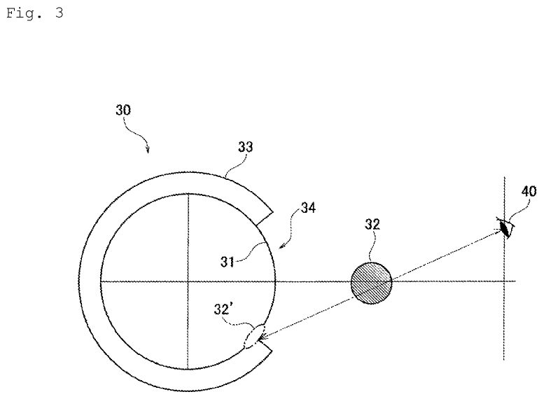

FIG. 3 is a diagram showing a state in which the pseudo pupil 32 blocks the line of sight of the observer such that the pupil is seen on the eyelid 33. In this case, there arises a problem that the entire pseudo pupil 32, which should be covered from view by the eyelid 33, can be visually recognized.

The display device 20 according to the present embodiment does not cause contradiction in the occlusion. Next, the display device 20 will be described.

### (Display Device)

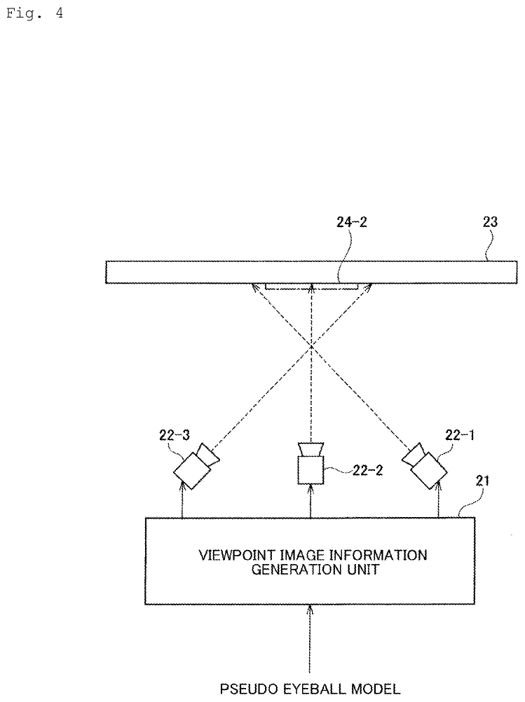

FIG. 4 is a diagram showing an example of a configuration of the display device 20 according to the embodiment. The display device 20 renders a pseudo eyeball image representing the pseudo eyeball based on the pseudo eyeball model 30, and then renders a display image of another display element.

As shown in FIG. 4, the display device 20 includes a viewpoint image information generation unit 21, a plurality of projection devices 22, and a screen 23. In this example, three projection devices 22-1, 22-2, and 22-3 are shown. It is sufficient for the number of projection devices 22 to be two or more. The screen 23 shows an example of a reflection type. The viewpoint 40 of the observer, which is not shown, is on the opposite side to the screen 23 with the plurality of projection devices 22 interposed therebetween.

The viewpoint image information generation unit 21 converts a pseudo eyeball into three pieces of image information, that is, image information obtained by viewing the pseudo eyeball from the right side by the observer, image information obtained by viewing the pseudo eyeball from the front by the observer, and image information obtained by viewing the pseudo eyeball from the left side by the observer, based on the pseudo eyeball model 30 input from the pseudo eyeball model generation device 10.

At the same time, the viewpoint image information generation unit 21 generates image information in which the face of the person is viewed in each direction. However, the facial expression may be the same. The viewpoint image information generation unit 21 outputs three pieces of image information including the face of a person and a pseudo eyeball to the projection device 22.

At this time, the viewpoint image information generation unit 21 renders a pseudo eyeball image representing the pseudo eyeball based on the pseudo spectacle model 30, and then renders a display image of another display element. The other display element is, for example, each element of the face. Thus, by drawing the pseudo eyeball model 30 prior to each element of the face, contradiction of occlusion can be prevented.

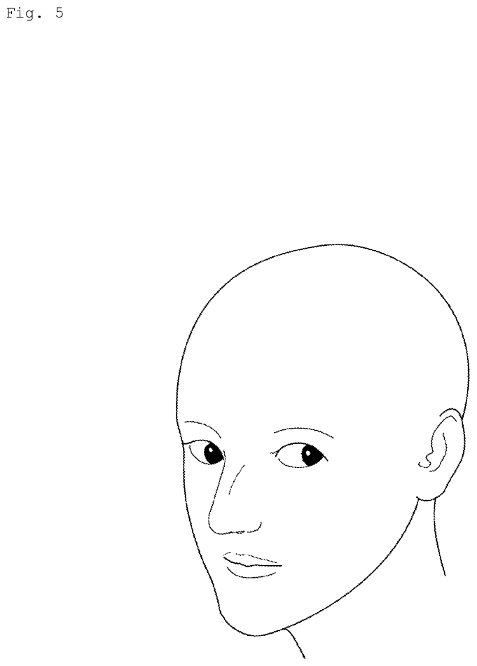

FIG. 5 is a diagram showing an example of a face image when the pseudo eyeball model 30 is drawn prior to each element of the face. As shown in FIG. 5, the outer edge portion of the pupil is hidden by the eyelid, and there is no contradiction in the occlusion.

The projection device 22-1 on the right side of the screen 23 projects image information obtained by viewing the face of the person and the pseudo eyeball from the left side. The projection device 22-2 located in front of the screen 23 projects image information obtained by viewing the face of the person and the pseudo eyeball from the front. The projection device 22-3 on the left side of the screen 23 projects image information obtained by viewing the face of the person and the pseudo eyeball from the right side.

Adjacent projection devices 22-1 and 22-2 and 22-2 and 22-3 project image information on the screen 23 in an overlapping manner. A projection surface 24-2 of the projection device 22-2 is shown on the surface of the screen 23. The projection device 22-1 projects a part of a projection surface 24-1 (not shown) on the left side of the projection surface 24-2 in an overlapping manner. The projection device 22-3 projects a part of a projection surface 24-3 (not shown) on the right side of the projection surface 24-2 in an overlapping manner.

The screen 23 is a screen in which the brightness of the displayed image is smoothly changed in accordance with the movement of the viewpoint. As a screen having such a characteristic, a “spatial imaging iris surface type screen” is known. The iris is a mechanism inside the projection device 22 and adjusts the amount of light corresponding to the diaphragm of the camera.

When the observer looks at the screen 23 while moving from the center of the central projection surface 24-2 to the projection surface 24-3, the observer perceives a stereoscopic image viewed by turning the face of the person including the pseudo eyeball from the front to the right. Looking at the screen 23 while moving from the center of the central projection surface 24-2 to the projection surface 24-1, the observer perceives a stereoscopic image viewed by turning the face of the person including the pseudo eyeball from the front to the left. In other words, a stereoscopic image having motion parallax can be displayed.

The display device 20 does not necessarily require the above-mentioned motion parallax. A display device, such as a multi-viewpoint display having a small number of viewpoints, in which monocular images can be switched according to the position of the observer, may be used.

As described above, the line-of-sight reproduction system 100 according to the present embodiment is a line-of-sight reproduction system including a pseudo eyeball model generation device 10 and a display device 20, in which the pseudo eyeball model generation device 10 generates a pseudo eyeball model 30 representing a pseudo eyeball with virtual eyeball information indicating a virtual eyeball 31 and pseudo pupil information obtained by moving a position of a pseudo pupil 32 from a surface of the virtual eyeball 31 to a side of an observer in association with a degree of gaze avoidance of deviating an eye line from a viewpoint 40 of the observer, and the display device 20 renders a pseudo eyeball image representing the pseudo eyeball based on the pseudo eyeball model 30, and then renders a display image of another display element. Thus, it is possible to reproduce an operation of not matching the line of sight (gaze avoidance).

Further, the display device 20 may display a different face image (facial expression) of a person in correspondence with the pseudo eyeball model 30. In this case, the viewpoint image information generation unit 21 uses the pseudo eyeball model 30 and emotion information as inputs.

The emotion information is information indicating various emotions such as anger, joy, and sadness. The viewpoint image information generation unit 21 displays a different face corresponding to the emotion information and a pseudo eyeball based on the pseudo eyeball model 30.

In this way, the display device 20 may receive emotion information expressing the emotion as an input and display the pseudo eyeball corresponding to the pseudo eyeball model 30 and the facial expression corresponding to the emotion information. According to this, the operation of not matching the line of sight (gaze avoidance) can be provided with a more rich emotional expression.

### (Diameter of Pseudo Pupil)

As described above, it has been described that the reproduction of the gaze avoidance operation can be performed by moving the position of the pseudo pupil 32 from the surface of the virtual eyeball 31 to the observer side. Here, a guideline for the sizes of the virtual eyeball 31 and the pseudo pupil 32 will be described.

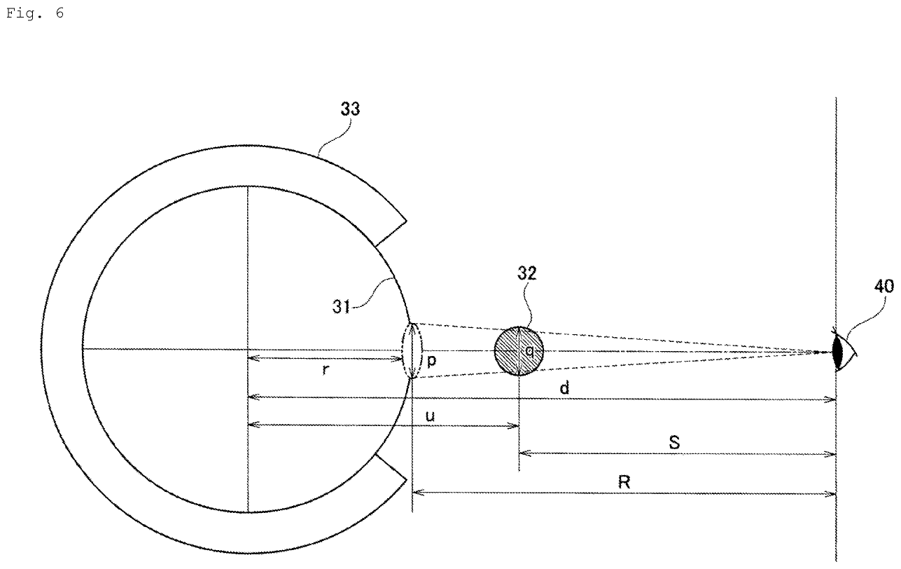

FIG. 6 is a diagram showing a relationship between the pseudo eyeball model 30 and the viewpoint 40 of the observer. In FIG. 6, q is the diameter of the pseudo pupil 32, p is the size of the pupil on the virtual eyeball, r is the radius of the virtual eyeball 31, u is the distance from the center of the virtual eyeball 31 to the center of the pseudo pupil 32, and d is the distance from the center of the virtual eyeball 31 to the viewpoint 40 of the observer.

The diameter q of the pseudo pupil 32 is calculated based on the following equation.

$$\begin{matrix}[ Math . 1 ] & \\ q = \frac{p S}{R} = \frac{p ( d - u )}{d - r} & ( 1 )\end{matrix}$$

In this way, the pseudo eyeball model generation device 10 generates the diameter q of the pseudo pupil 32 by multiplying a ratio of a distance S between the center of the pseudo pupil 32 and the viewpoint 40 of the observer and a distance R between the surface of the virtual eyeball 31 on the observer side and the viewpoint 40 of the observer by the size p of the pupil on the virtual eyeball. Thereby, a pseudo eyeball model 30 capable of displaying a pseudo eyeball of an appropriate size can be generated.

### (Line-of-Sight Reproduction Method)

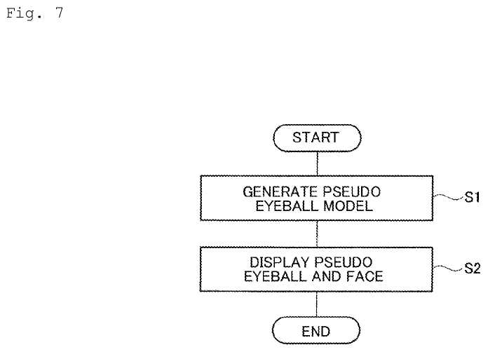

FIG. 7 is a flowchart showing a processing procedure of a line-of-sight reproduction method performed by the line-of-sight reproduction system 100 according to the present embodiment.

The pseudo eyeball model generation device 10 generates the pseudo eyeball model 30 representing the pseudo eyeball with virtual eyeball information indicating the virtual eyeball 31 and pseudo pupil information obtained by moving the position of the pseudo pupil 32 from the surface of the virtual eyeball 31 to the observer side in association with the degree of gaze avoidance of deviating an eye line from the viewpoint 40 of the observer (step S1).

The display device 20 renders a pseudo eyeball image representing the pseudo eyeball based on the pseudo eyeball model 30, and then renders a display image of another display element (step S2). Thus, it is possible to reproduce an operation of not matching the line of sight (gaze avoidance).

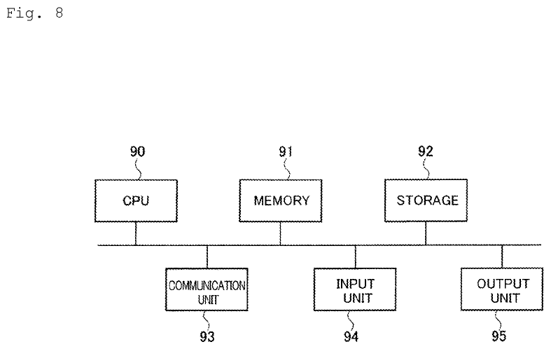

The line-of-sight reproduction system 100 can be realized by a general-purpose computer system shown in FIG. 8. For example, in a general-purpose computer system including a CPU 90, a memory 91, a storage 92, a communication unit 93, an input unit 94, and an output unit 95, each function of the line-of-sight reproduction system 100 is realized by the CPU 90 executing a predetermined program loaded on the memory 91. A predetermined program can be stored on a computer-readable recording medium such as an HDD, an SSD, a USB memory, a CD-ROM, a DVD-ROM, or an MO and can also be distributed via a network.

The present invention is not limited to the above embodiment, and can be modified without departing from the scope of the gist of the invention. For example, although the screen 23 of the display device 20 has been described with reference to an example of a reflection type, the present invention is not limited to this example. The screen 23 may be of a transmission type. In the case of a transmission type screen, an observer observes the pseudo eyeball with light transmitted through the screen.

Although the information on the “degree of gaze avoidance” has been described with reference to an example in which the information is input from the outside, the present invention is not limited to this example. For example, a line-of-sight generation unit that generates information on the “degree of gaze avoidance” along a scenario may be provided.

In this manner, the present invention includes various embodiments etc., not described herein, as a matter of course. Thus, the technical scope of the present invention is only defined by invention specifying matters in the claims that are appropriate from the above description.

### REFERENCE SIGNS LIST

10 Pseudo eyeball model generation device
20 Display device
21 Viewpoint image information generation unit
22-1 to 22-3 Projection device
23 Screen
30 Pseudo eyeball model
31 Virtual eyeball
32 Pseudo pupil
33 Eyelid
40 Viewpoint of observer
100 Line-of-sight reproduction system

1. A line-of-sight reproduction system comprising:
a pseudo eyeball model generation device; and
a display device,
wherein the pseudo eyeball model generation device is configured to generate pseudo eyeball model representing a pseudo eyeball with virtual eyeball information indicating a virtual eyeball and pseudo pupil information obtained by moving a position of a pseudo pupil from a surface of the virtual eyeball to a side of an observer in association with a degree of gaze avoidance of deviating an eye line from a viewpoint of the observer, and
the display device configured to render a pseudo eyeball image representing the pseudo eyeball based on the pseudo eyeball model, and then render a display image of another display element.

2. The line-of-sight reproduction system according to claim 1, wherein the pseudo eyeball model generation device is configured to determine diameter of the pseudo pupil based on a ratio of a distance between a viewpoint of the observer located in front of the pseudo eyeball and a center of the pseudo pupil to a distance between the viewpoint and a surface of the virtual eyeball on a side of the observer.

3. The line-of-sight reproduction system according to claim 1, wherein the display device is configured to receive emotion information expressing an emotion as an input, and render the pseudo eyeball image and a face image corresponding to the emotion information.

4. A line-of-sight reproduction method performed by a line-of-sight reproduction system including a pseudo eyeball model generation device and a display device, the method comprising:
generating, by the pseudo eyeball model generation device, a pseudo eyeball model representing a pseudo eyeball with virtual eyeball information indicating a virtual eyeball and pseudo pupil information obtained by moving a position of a pseudo pupil from a surface of the virtual eyeball to a side of an observer in association with a degree of gaze avoidance of deviating an eye line from a viewpoint of the observer; and
rendering, by the display device, a pseudo eyeball image representing the pseudo eyeball based on the pseudo eyeball model, and then rendering, by the display device, a display image of another display element.

5. A non-transitory computer readable medium storing one or more instructions causing a computer to function as a line-of-sight reproduction system including a pseudo eyeball model generation device and a display device to execute:
generating, by the pseudo eyeball model generation device, a pseudo eyeball model representing a pseudo eyeball with virtual eyeball information indicating a virtual eyeball and pseudo pupil information obtained by moving a position of a pseudo pupil from a surface of the virtual eyeball to a side of an observer in association with a degree of gaze avoidance of deviating an eye line from a viewpoint of the observer; and
rendering, by the display device, a pseudo eyeball image representing the pseudo eyeball based on the pseudo eyeball model, and then rendering, by the display device, a display image of another display element.

6. The line-of-sight reproduction method according to claim 4, comprising:
determining, by the pseudo eyeball model generation device, a diameter of the pseudo pupil based on a ratio of a distance between a viewpoint of the observer located in front of the pseudo eyeball and a center of the pseudo pupil to a distance between the viewpoint and a surface of the virtual eyeball on a side of the observer.

7. The line-of-sight reproduction method according to claim 4, comprising:
receiving, by the display device, emotion information expressing an emotion as an input, and rendering the pseudo eyeball image and a face image corresponding to the emotion information.

8. The non-transitory computer readable medium according to claim 5, wherein the one or more instructions cause the computer to execute:
determining, by the pseudo eyeball model generation device, a diameter of the pseudo pupil based on a ratio of a distance between a viewpoint of the observer located in front of the pseudo eyeball and a center of the pseudo pupil to a distance between the viewpoint and a surface of the virtual eyeball on a side of the observer.

9. The non-transitory computer readable medium according to claim 5, wherein the one or more instructions cause the computer to execute:
receiving, by the display device, emotion information expressing an emotion as an input, and rendering the pseudo eyeball image and a face image corresponding to the emotion information.
